(19) United States
(12) Patent Application Publication
(10) Pub. No.: US 2006/0209575 A1
(43) Pub. Date: Sep. 21, 2006

(54) Fixed frequency resonant converter

(76) Inventor: Michael Archer, Newbury Park, CA (US)

Correspondence Address: John A Scillieri;Seldon and Scillieri, 10940 Wilshire Blvd, 18th Floor, Los Angeles, CA, 90024, US

(21) Appl. No.: 10/544,462

(22) PCT Filed: Feb. 4, 2004
(86) PCT No.: PCT/US04/03075

§ 371 Date: Feb. 21, 2006

Related U.S. Application Data
(60) Provisional application No. 60/445,198, filed on Feb. 4, 2003.

(51) Int. Cl. H02M 3/335

(52) U.S. Cl. 363/22

(57) ABSTRACT

A low cost drive circuit forming part of a high efficiency fixed frequency resonant mode converter. The drive circuit is self synchronizing, and utilizes relatively inexpensive components in synchronizing a MOSFET transistor output stage to a primary resonant current in a DC to DC converter.

### CROSS-REFERENCE TO RELATED APPLICATION

This Application claims priority of co-pending U.S. Provisional Application No. 60/445,198, filed Feb. 4, 2003.

### BACKGROUND OF THE INVENTION

DC to DC converters are relatively common today, and are used in a variety of applications, and particularly in topologies involving forward converters, half bridge and full bridge circuit arrangements, and forward converters, where the current is forced to be in synchronous relationship with the primary switch, as for example, a primary MOSFET switch.

Many of these applications involving the DC to DC converters are used in low voltage systems, such as in computers where the point of load control and efficiency is quite important. Exemplary of some of these uses include desktop and notebook computers. Applications in these environments would be beneficial since the drive logic for the primary switches and the drive logic for the synchronous switches are referenced to either a common ground or voltage differential. Typically, a voltage of twelve to twenty volts may be stepped down with a common reference to 5 volts, or less.

Power converters that are used to convert AC to DC from the world wide AC voltage standard (90VAC-264VAC) have been relatively free of the synchronous approaches used in conventional low voltage type DC to DC converters, mentioned above. The reason for this is varied, but some of the most important issues have been the complexity of driving the secondary stage in sync with a primary stage that is separated by the safety load line boundary which dictates a dielectric breakdown potential of 3,000VAC along with strict clearance requirements in the boundary components. Crossing this boundary with the necessary information is possible but tends to be quite expensive.

In addition to the above, the converters are operating at much higher voltages than their low voltage DC to DC counterparts and a number of more difficult issues arise when the converter is using forced commutation. The disadvantages of forced commutation are found in the conventional approaches used in the industry for the low voltage fields. The most significant is managing the effects of leakage inductance from the main transformer and t his leakage inductance acts to distort the power current, voltages and drive signals. The effect also causes inherent timing issues, since the leakage energy must be depleted before the primary current will initiate making the timing of the synchronous switches difficult.

There has been a need for a very high efficiency AC to DC converter which operates off of the universal line range. This need has become paramount with the proliferation of desktop and notebook computers, and particularly, the high density desktop and notebook computers. Pricing of this hardware has recently been dropping in the marketplace, making the design challenge far more difficult. This, coupled with the fact that there is an imposition of stricter measures to curtail waste of energy, adds to the design problem. Thus, there is definitely a need for a cost effective solution to obtaining a high efficiency AC to DC converter.

### OBJECTS OF THE INVENTION

It is therefore, one of the primary objects of the present invention to provide a highly efficient AC to DC converter for use with high density desktop and notebook computers.

It is another object of the present invention to provide an AC to DC converter of the type stated, which is highly efficient in the use of energy and allows for a low price frequency resonant mode converter.

### SUMMARY OF THE INVENTION

A high frequency resonant converter is one which operates at a defined frequency, and particularly, in a way such that load currents are passed between the primary and secondary windings of the main power transformer. In addition, the operation occurs with sinusoidal waveforms, where the current begins and ends at essentially zero current point. The present invention removes the problems associated with magnetic leakage inductance through a depletion of the breakage field of energy, even before the power conversion cycle has ended. In other words, the power conversion cycle will continue for a short time, thereby allowing a leakage of the field energy.

In accordance with the invention, a sync winding is stacked up on top of secondary power winding, of a type which supplies voltage to a MOSFET power stage. This additional sync winding is used to initiate the start of a simple one shot. The one shot is preferably made of a low cost comparator and is operated with reference to the MOSFET source and the power winding output. The aforesaid extra sync winding provides a bias for the comparator. When the voltage on the main transformer is positive with respect to a ground voltage on one side of the transformer, the circuit is tied to the winding which supplies a positive voltage to the MOSFET gate. This will cause an energization or turning on of the MOSFET gate. In addition, this operation is usually in synchronous relationship with the primary switch, since the synchronous winding is in phase with the primary winding being driven by a switch, namely, the MOSFET transistor.

Inasmuch as the synchronous voltage is only available while the correctly phased primary MOSFET switch is on, it is not possible to leave the secondary synchronous MOSFET out of the phase. This is true regardless of any potential controller error, and also true since there is no available dry voltage to charge the gate. The synchronous winding also initiates the one shot, making the need for any additional time constant, other than on time programming unnecessary, and insuring programming of production tolerances.

This present invention thereby provides a unique and novel improved fixed frequency resonant converter, which thereby fulfills all of the above-identified objects and other objects which will become more fully apparent from the consideration of the forms in which it may be embodies. One of these forms is more fully illustrated in the accompanying drawings and described in the following detailed description of the invention. However, it should be understood that the accompanying drawings and this detailed description are set forth only for purposes of illustrating the general principles of the invention.

### BRIEF DESCRIPTION OF THE DRAWINGS

In the accompanying drawings:

FIG. 1 is a schematic circuit view of a conventional prior art frequency resonant mode converter;

FIG. 2 is a series of diagrammatic waveforms produced by the circuit arrangement of FIG. 1;

FIG. 3 is a prior art schematic diagram of one form of a frequency resonant converter;

FIG. 4 is a schematic circuit diagram of a preferred fixed frequency resonant mode converter of the present invention; and

FIG. 5 are schematic waveform diagrams, produced in accordance with the arrangement of FIG. 4.

### DETAILED DESCRIPTION OF PREFERRED EMBODIMENT

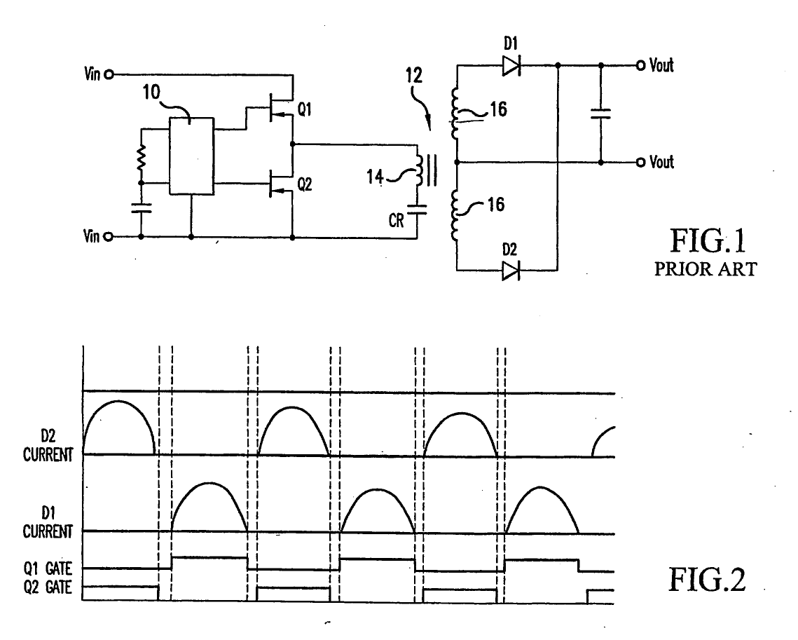

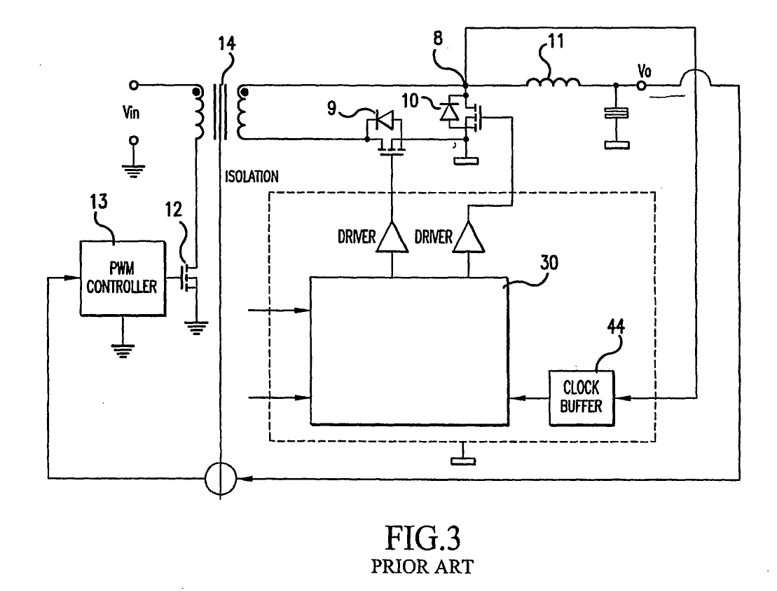

Referring now to the prior art, and particularly FIG. 1, it can be observed that there are a pair of MOSFET transistors or switches, Q1 and Q2, operating with a simple oscillator 10. There is a main power transformer 12, having a primary winding 14, and secondary windings 16, with diodes serving as rectifiers, D1 and D2.

By further reference to FIG. 1, it can be seen that the rectifiers D1 and D2 are conducting in the waveform shown beneath the circuit or diagram. This same waveform diagram also shows when the gates Q1 and Q2 are operating. In fact, the gate for Q2 is energized when the diode D2 is conducting. In like manner, the gate for Q1 is operating when the diode D1 is operating.

One of the problems in the circuit arrangement of FIG. 1 is the control of the MOSFET switches, that is, to synchronously turn them off and on. It must be recognized that this circuit arrangement must be used essentially anywhere in the world. In addition, there must be isolation to protect the user from a voltage source as large as 3,000 volts. In addition to the foregoing, the prior art arrangement as exemplified by FIG. 1, does not operate efficiently. Indeed, it can be observed that FIG. 3 illustrates an arrangement with a half and full bridge arrangement and forward converters, which force commutates the current in synchronous relationship with the primary switch.

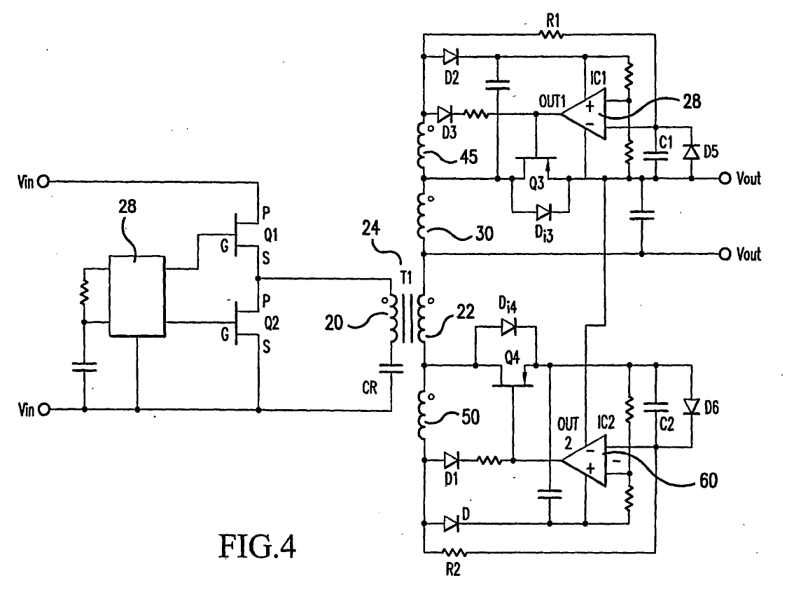

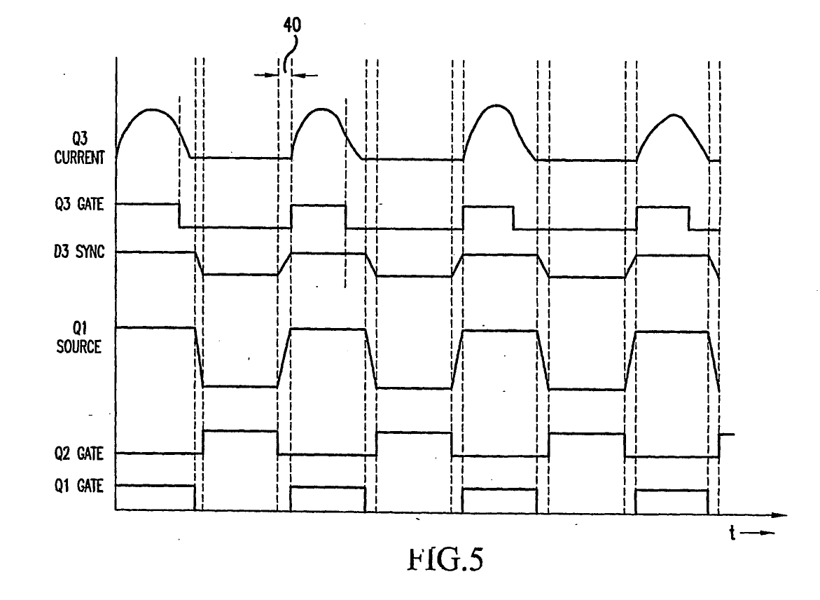

FIG. 4 illustrates the fixed frequency resonant converter of the present invention. This converter similarly uses the MOSFET switches Q1 and Q2. In this case, the current in the primary 20 is mutually coupled to the current in the secondary windings 22, 30, 45 and 50 of a main transformer 24. By reference to FIG. 5, it can be seen that half sine waveforms generated with a current begins and ends at essentially zero. Using this arrangement, the leakage field of energy is depleted before the power conversion cycle has ended.

The waveform illustrated at the gate Q3 is essentially the output of the comparator 28. In short, the invention is unique in that only a very simple comparator is used. The diodes D1 and D3 are used with the synchronous switches Q1 and Q2, and are in synchronous relationship with the switches Q1 and Q2. By further reference to FIG. 5, it can be seen that there is a short time duration designated as 40, during which the forward resonant current will end and the diodes D1 and D3 will conduct. After the completion of the one shot timing for IC1 (28) and IC2 (60), the intrinsic diodes present in Q3 and Q4 (i.e., the intrinsic diodes Dᵢ₃ and Dᵢ₄) continue carrying the remaining load current until the end of the resonant cycle, thus removing the need for high accuracy in the comparator IC1 (28) and IC2 (60).

Thus there has been illustrated and described a unique and novel improved fixed frequency resonant converter, and which thereby fulfills all of the objects and advantages which have been sought. It should be understood that many changes, modifications, variations, and other uses and applications will become apparent to those skilled in the art after considering this specification and the accompanying drawings. Therefore, any and all such changes, modifications, variations and other uses and applications which do not depart from the spirit and scope of the invention are deemed to be covered by the invention.

Having thus described the invention, what I desire to claim is:

1. A low cost self synchronizing drive circuit for use with a fixed frequency resonant converter, said drive circuit comprising:
a) a pair of connected transistor switches;
b) a comparator circuit arrangement connected across said transistors;
c) a transformer having a primary and secondary winding;
d) a pair of diodes connected across the primary and secondary windings of said transformer; and
e) an additional synchronizing winding associated with the secondary winding of said transformer and providing a bias for said comparator.
